(19) United States
(12) Patent Application Publication
(10) Pub. No.: US 2024/0339725 A1
(43) Pub. Date: Oct. 10, 2024

(54) SEPARATOR FOR LITHIUM ION SECONDARY BATTERY WITH IMPROVED CHARGE-DISCHARGE PERFORMANCE AND THERMAL STABILITY AND METHOD FOR MANUFACTURING THE SAME

(71) Applicant: Pukyong National University Industry-University Cooperation Foundation, Busan (KR)

(72) Inventors: Kie Yong CHO, Busan (KR); Jae Won PARK, Busan (KR); Young Je KWON, Busan (KR); Min Jeong LEE, Miryang-si (KR)

(73) Assignee: Pukyong National University Industry-University Cooperation Foundation, Busan (KR)

(21) Appl. No.: 18/623,141

(22) Filed: Apr. 1, 2024

(30) Foreign Application Priority Data
Apr. 4, 2023 (KR) 10-2023-0043944

(51) Int. Cl. H01M 50/426; H01M 10/0525; H01M 50/403; H01M 50/491

(52) U.S. Cl. CPC H01M 50/426; H01M 50/403; H01M 50/491; H01M 10/0525

(57) ABSTRACT

A separator for lithium-ion secondary batteries is characterized in that DPVDF is dip-coated on the separator and crosslinked. A material of the separator is selected from polyethylene (PE), polypropylene (PP), cellulose acetate (CA), polyvinylidene fluoride (PVDF), polyethersulfone (PES), or polyethylene terephthalate (PET). A method for manufacturing the separator includes: synthesizing polyvinylidene fluoride (DPVDF) including a double bond by dehydrochlorinating poly(vinylidene fluoride-co-chlorotrifluoroethylene [P(VDF-CTFE)]; coating a separator by dipping in a dipping solution formed by dissolving the DPVDF in an organic solvent; and crosslinking the DPVDF coated on the separator by performing a radical reaction by heat treatment.

### CROSS-REFERENCE TO PRIOR APPLICATION

This application claims priority to Korean Patent Application No. 10-2023-0043944 (filed on Apr. 4, 2023), which is hereby incorporated by reference in its entirety.

### BACKGROUND

The present invention relates to a separator for lithium ion secondary batteries with improved charge-discharge performance and thermal stability and a method of manufacturing the same. More specifically, the present invention relates to a separator for lithium ion secondary batteries with improved charge-discharge performance and thermal stability and a method of manufacturing the same, characterized in that polyvinylidene fluoride (DPVDF) is used to a separator through dip coating and crosslinking reaction to improve thermal stability and electrochemical performance so that the separator is used as a separator for secondary batteries.

Recently, as the importance of increasing the proportion of clean energy to respond to environmental regulations such as the UN Framework Convention on Climate Change has emerged, the market for lithium-ion secondary batteries is rapidly increasing. However, as fires due to battery explosions occur frequently, questions are raised about the safety of batteries.

The role of a separator, which is responsible for the stability of a battery, is to electrically separate a cathode and anode, thereby preventing internal short circuits and providing a path for lithium ions to diffuse between the two electrodes.

Polyolefin-based separators are often used in these separators, but the performance of polyolefin-based separators is limited due to their poor thermal stability and relatively low affinity to electrolytes.

However, fluorine-based polymers have excellent thermal and electrochemical stability, excellent mechanical properties, a relatively excellent affinity to electrolytes compared to polyolefin-based polymers, and a high dielectric constant, so that they may help with lithium ion diffusion by dissociating lithium salts.

Meanwhile, as existing materials used as separators, fluorine-based polymers such as polyvinylidene fluoride (hereinafter referred to as ‘PVDF’) and poly(vinylidene fluoride-co-hexafluoropropylene) (hereinafter referred to as ‘PVDF-HFP’) are used as a material for dip-coating separators made of polypropylene (PP) materials because they have low crystallinity, but the materials are limited in increasing stability and physical stability.

In addition, fluorine-based polymers such as PVDF and PVDF-HFP inherently have a very stable structure, so further modification is difficult. Therefore, surface modification was performed by mixing with other materials rather than by chemical modification, so it was very difficult to control the surface morphology.

Therefore, the present inventors developed a separator for lithium ion secondary batteries with improved charge-discharge performance and thermal stability that can solve the problems described above, thereby completed the present invention.

### PRIOR ART DOCUMENTS

[Patent document 001] Korea Patent Registration 10-2198401 (registered on Dec. 29, 2020) “Membrane with superior solute rejection performance using aromatic hydrocarbons and its manufacturing technique”
[Patent document 002] Korea Patent Registration 10-1630208 (registered on Jun. 8, 2016) “A preparation method of hydrophilic membrane and a hydrophilic membrane prepared by the same”

### SUMMARY

To solve the problems described above, one object of the present invention is to provide a separator for lithium ion secondary batteries with improved charge-discharge performance and thermal stability and a method of manufacturing the same, characterized in that DPVDF is used to a separator through dip coating and crosslinking reaction to improve thermal stability and electrochemical performance, thereby utilizing the separator as a separator for secondary batteries.

In particular, another object of the present invention is to provide a separator for lithium ion secondary batteries with improved charge-discharge performance and thermal stability and a method of manufacturing the same, characterized in that surface modification treatment is performed using, as a coating material for a separator, DPVDF, which is a polymer compound synthesized by dehydrochlorination of PVDF, an existing fluorine-based polymer material that is difficult to modify further, so that surface morphology before dip coating is maintained even after dip coating and thus the performance of the properties described above does not deteriorate.

A preferred embodiment of the present invention for achieving the above objects is a separator for lithium-ion secondary batteries with improved charge-discharge performance and thermal stability, characterized in that DPVDF is dip-coated on the separator and crosslinked.

In addition, a material of the separator is polyethylene (PE) or polypropylene (PP), and the separator is coated with 0.05% to 10% by weight of DPVDF, and pores are formed, and the size of the pores is 10 nm to 35 μm in diameter, and the coating thickness of DPVDF is 0.05 to 3 μm.

Meanwhile, another preferred embodiment of the present invention is a method for manufacturing a separator for lithium-ion secondary batteries with improved charge-discharge performance and thermal stability, comprising: a step (S100) of synthesizing polyvinylidene fluoride (DPVDF) including a double bond by dehydrochlorinating poly(vinylidene fluoride-co-chlorotrifluoroethylene [P(VDF-CTFE)]; a step (S200) of coating a separator by dipping in a dipping solution formed by dissolving the DPVDF in an organic solvent; and a step (S300) of crosslinking the DPVDF coated on the separator by performing a radical reaction by heat treatment.

In addition, in the step S100, synthesis is performed by adding P(VDF-CTFE) into an organic solvent and dissolving therein and then adding an amine-based organic catalyst.

In addition, in the step S300, a radical initiator is selected from 2,2′-azobisisobutyronitrile (AIBN), benzoyl peroxide (BPO), lauryl peroxide, azobisisocapronitrile, azobisisovaleronitrile, methyl ethyl ketone peroxide (MEKP), potassium persulfate, di-tert-butyl peroxide, or 1,1′-dihydroxydicyclohexyl peroxide, and a crosslinking reaction is performed for 4 to 12 hours at a temperature of 70 to 150° C.

A separator for lithium ion secondary batteries according to the present invention is surface-modified using PVDF-CTFE which is a polymer compound synthesized by dehydrochlorination of PVDF, an existing fluorine-based polymer material, and thus has excellent effects of exhibiting excellent thermal stability, as surface morphology before dip coating is maintained even after dip coating, improving solubility of an electrolyte, as a path through lithium ions are transported is improved due to the improvement of pore structure and thus the ion conductivity of the separator is increased, and exhibiting excellent electrochemical performance in charge-discharge performance and flame resistance of a separator compared to existing PP separators.

### BRIEF DESCRIPTION OF THE DRAWINGS

FIG. 1 shows a process block diagram for explaining a manufacturing process of separators for lithium-ion secondary batteries with improved charge-discharge performance and thermal stability according to a preferred embodiment of the present invention.

FIGS. 2 and 3 show SEM photographs (×50000) of a pore structure of a surface and a cross-section of the separators coated with DPVDF at different concentrations.

FIG. 4 shows SEM photographs (×50000, 7500) of pore structure morphology of DPVDF-coated separators and graphs showing the results of analyzing electrolyte uptake, porosity, and electrolyte contact angle.

FIG. 5 shows graphs showing the results of analyzing electrolyte uptake amount and contact angle of the separators.

FIG. 6 shows graphs showing the results of analyzing gas permeability of a separator.

FIG. 7 shows graphs showing a crosslinking effect of a DPS separator by an FT-IR analysis.

FIG. 8 shows SEM photographs (×7500) showing the results of an FE-SEM morphological analysis to observe morphology maintenance of the separators after a crosslinking reaction.

FIG. 9 shows a photograph showing the results of a thermal property analysis and graphs showing the thermal property results.

FIG. 10 shows graphs showing the results of an analysis on ionic conductivity and electrochemical stability of the separators.

FIG. 11 shows graphs showing the results of an electrochemical analysis of the separators.

FIG. 12 shows graphs showing the results of measuring electrical conductivity and open circuit voltage of the separators;

FIG. 13 shows photographs showing the results of a flame resistance test of the separators and the results of a weight analysis after combustion.

FIG. 14 shows SEM photographs (×20,000, ×200, ×10,000) of pore structures formed in each separator made of PVDF, PET, and PES materials.

### DETAILED DESCRIPTION

Hereinafter, the present invention will be described in detail according to preferred embodiments of the present invention with reference to the accompanying drawings, but detailed description of the configuration and operation that can be easily known to those skilled in the art will be omitted. In addition, it should be noted that the present invention is not necessarily limited by the following examples, and that those skilled in the art can make various changes to the present invention without departing from the technical spirit of the present invention.

Hereinafter, a separator for lithium ion secondary batteries (hereinafter referred to as ‘separator for secondary batteries’) according to a preferred embodiment of the present invention will be described in detail as follows.

A separator for secondary batteries according to the present invention is a separator that is crosslinked by coating the separator with polyvinylidene fluoride (double-bond contained olyvinylidene fluoride, hereinafter referred to as ‘DPVDF’), specifically characterized in that thermal stability and electrochemical performance were improved through dip coating and crosslinking performed by using DPVDF having a structure as shown in Formula 1 above.

For reference, DPVDF used in the present invention is a fluorine-based polymer compound including a double bond synthesized by dehydrochlorinating poly(vinylidene fluoride-co-chlorotrifluoroethylene [hereinafter referred to as ‘P(VDF-CTFE)’] having a structure shown in Formula 1 below, and a structural formula thereof is represented by Formula 2 below.

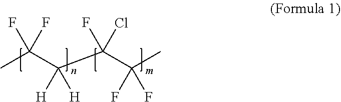

In Formula 1, n is preferably 4,500 to 4,800, and m is preferably 1,200.

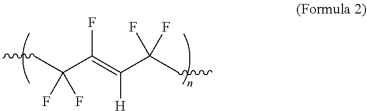

In Formula 2, n is preferably 1,100-1,150.

In addition, the material of the separator is preferably selected from polyethylene (PE), polypropylene (PP), cellulose acetate (CA), polyvinylidene fluoride (PVDF), polyethersulfone (PES), or polyethylene terephthalate (PET), but it is not necessarily limited to the materials listed above, and all materials having properties higher than or equal to the materials listed above may be applied.

In addition, the separator is crosslinked after DPVDF coating, forming morphology on a DPVDF-coated surface of the separator and exhibiting excellent affinity to an electrolyte, so that the separator uptakes a relatively greater amount of electrolyte than a conventional separator.

Electrolyte uptake, one of the indicators of performance evaluation of separators for secondary batteries, is a key factor in determining ionic conductivity of separators for secondary batteries, and their performance is determined by coating conditions of a fluorine-based polymer compound, which is a material that modifies a surface of secondary battery separators.

Therefore, a coating amount of DPVDF of a fluorine-based polymer compound coated on a separator is preferably 0.05% to 10% by weight (dry basis), and more specifically, 3% to 5% by weight (dry basis).

When a DPVDF coating amount of the separator is less than the above-limited range, there is a risk that a pore structure may not be properly formed on a surface of the separator, and when it exceeds the above-limited range, the pore structure morphology formed on a surface of the separator may be changed and sealed and the dispersion properties of lithium ions may be lowered, thereby lowering the performance.

In addition, the size of pores formed on a surface and in the inside of a separator for secondary batteries is preferably 10 nm to 35 μm in diameter, the porosity is preferably 40% to 65% (v/v), and the coating thickness of DPVDF is preferably 0.05 to 3 μm. When the material of a separator is PP, the size of pores formed on a surface and in the inside of a separator for secondary batteries is preferably 20 to 40 nm in diameter.

When the pore size and porosity conditions and the coating thickness of DPVDF are less than the above-limited ranges, there is a risk that lithium ion permeability may decrease due to the small pore size, small porous pore volume, or small coating thickness formed on a surface of a separator, and when it exceeds the above-limited ranges, there is a risk that the pores are completely sealed and lithium ions may not penetrate.

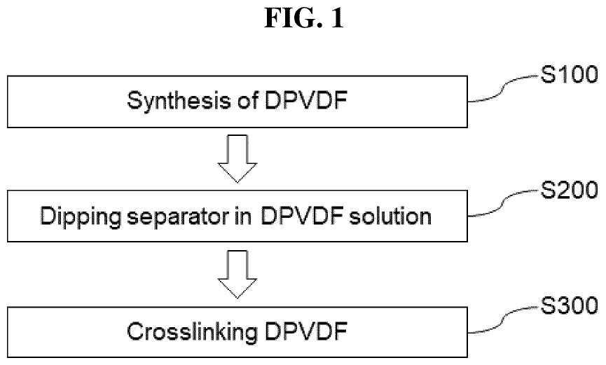

Hereinafter, a method of manufacturing a separator for lithium ion secondary batteries according to a preferred embodiment of the present invention will be described in detail with reference to FIG. 1 attached to the specification as follows.

For reference, FIG. 1 shows a process block diagram for explaining a manufacturing process of separators for lithium-ion secondary batteries with improved charge-discharge performance and thermal stability according to a preferred embodiment of the present invention.

A method for manufacturing a separator for secondary batteries according to the present invention includes: a DPVDF synthesis step (S100); separator dipping step (S200); and a DPVDF crosslinking step (S300).

The DPVDF synthesis step (S100) is a step of dissolving P(VDF-CTFE) in an organic solvent and then synthesizing DPVDF by adding a triethylamine (TEA) catalyst, and during a synthesis reaction, a —Cl group bonded to PVDF-CTFE is detached by dehydrochlorination of PVDF-CTFE and a double bond is formed so that DPVDF is synthesized.

The organic solvent is one or more solvents selected from dimethylformamide (DMF), tetrahydrofuran (THF), or N-methylpyrrolidone (NMP), and the organic catalyst is an organic catalyst containing an amine group, preferably an organic catalyst containing a tertiary amine group, and an organic catalyst selected from triethylamine (TEA), tripropylamine (TPA), or triphenylamine (NPh₃). As shown below, Formula 3 shows the structural formula of TEA, Formula 4 shows the structural formula of TPA, and Formula 5 shows the structural formula of NPh₃.

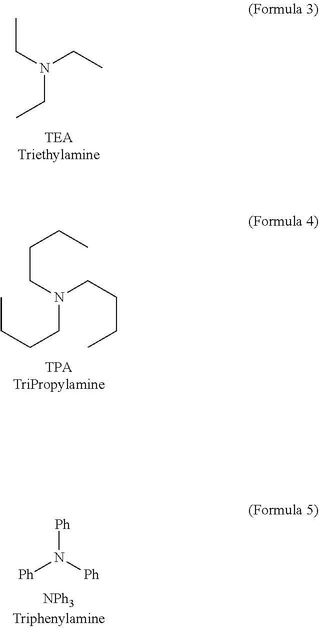

Among the above organic catalysts, since it may be confirmed from [Table 1] that TEA has the highest conversion ratio over the same time, it is more preferable to use TEA as a catalyst.

TABLE 1

| | Reaction | | Reaction | Conversion |
|---|---|---|---|---|
| | temperature | Solvent | Time | Ratio |
| Catalyst | (° C.) | (ml) | (Hour) | (%) |
| TEA | 50 | 10 | 24 | 96 |
| TPA | 50 | 10 | | 84 |
| NPH₃ | 50 | 10 | | 73 |

In this step, dissolution is preferably performed for 11 to 13 hours at 48 to 52° C., and synthesis is preferably performed for 92 to 98 hours at 48 to 52° C. However, the temperature and time for dissolution and synthesis are not necessarily limited to the above temperature and time and may be adjusted appropriately.

The separator dipping step (S200) is a step of coating a separator by dipping it in a dipping solution formed by dissolving DPVDF in an organic solvent, and it is preferable that a separator is completely immersed in the dipping solution for 50 to 70 seconds.

The dipping solution used in this step is specifically a solution formed by dissolving DPVDF in an organic solvent, and it is preferable that the organic solvent is specifically one or more solvents selected from acetone, dimethylformamide (DMF), dimethylacetamide (DMAc), triethyl phosphate (TEP), or N-methyl-2-pyrrolidone (NMP), and specifically, it is more preferable that it is acetone.

In a coating process, a PP separator is completely immersed in a DPVDF acetone solution, allowed to stand for 50 to 70 seconds so that sorption occurs inside the separator, and then taking it out as slowly as possible and drying it.

The DPVDF crosslinking step (S300) is a step of adding DPVDF coated on the separator above and a radical initiator to an organic solvent to perform crosslinking.

In this step, movement between polymer chains is suppressed through a crosslinking reaction between polymers, and physical properties such as thermal stability and affinity with an electrolyte are improved through bonding.

In addition, by crosslinking and heat-treating DPVDF, the pore structure is improved, and the path through which lithium ions are transported is improved accordingly, increasing the ionic conductivity of the separator, and so the separator in which DPVDF is crosslinked has an effect of improving charge-discharge capacity compared to existing PP separators.

An organic solvent used in this step is a degassed solvent for the purpose of suppressing side reactions caused by oxygen remaining in the solvent. Specifically, it is one or more solvents selected from methanol, ethanol, propanol, isopropanol, DMF or NMP, or acetone, and specifically, ethanol is more preferable.

In addition, a radical initiator is an initiator selected from 2,2′-azobisisobutyronitrile (AIBN), benzoyl peroxide (BPO), lauryl peroxide, azobisisocapronitrile, azobisisovaleronitrile, methyl ethyl ketone peroxide (MEKP), potassium persulfate, di-tert-butyl peroxide or 1,1′-dihydroxydicyclohexyl peroxide, and it is preferably AIBN.

In addition, a crosslinking reaction is preferably performed for 4 to 12 hours at a temperature of 70 to 140° C., followed by washing with ethanol and drying for two to three hours at a temperature of 30 to 100° C., but the temperature and time for the crosslinking reaction and drying are not necessarily limited to the temperature and time described above and may be adjusted appropriately.

For reference, a crosslinking reaction of DPVDF is shown in Scheme 1 below.

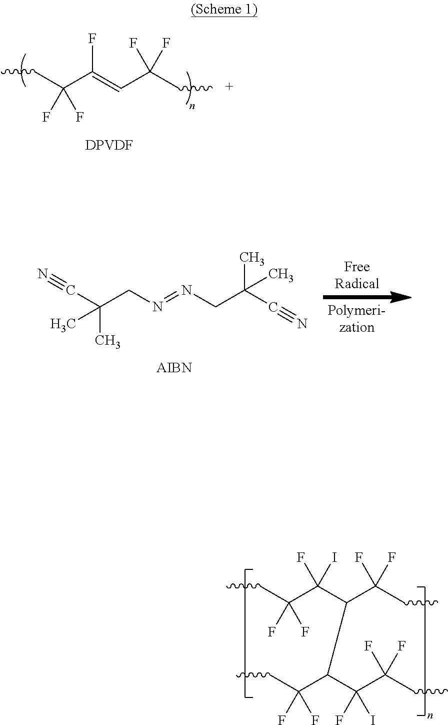

In Scheme 1, n is preferably 1,100 to 1,150.

Hereinafter, a DPVDF-coated separator for lithium ion secondary batteries according to the present invention will be described in detail through the examples below, and the present invention is not necessarily limited to the examples below.

### Example 1. Synthesis of DPVDF

10 g of PVDF-CTFE (Solvay Co., Ltd., Solfe 32008) was dissolved in 100 ml of NMP at 50° C. for 12 hours, and then TEA was added and allowed to react at 50° C. for 96 hours to synthesize DPVDF. The DPVDF was dissolved in an acetone solvent each at 0.1%, 0.5%, 1%, 3%, 5%, 7%, and 9% by weight, and then a commercial PP separator (Celgard 2400) was completely immersed in the acetone solution in which DPVDF was dissolved, allowed to stand for 60 seconds so that sorption occurred to the inside of the separator, and then it was slowly taken out and vacuum dried at a temperature of 30° C. for one hour to synthesize DPVDF.

### Example 2. Manufacturing DPVDF-Coated and Crosslinked Separator for Lithium Ion Secondary Batteries

0.05 g of DPVDF coated on the separator was added to 50 ml of degassed ethanol, then 0.014 g of AIBN, a radical initiator, was added, and then the resulting mixture was each allowed to undergo a crosslinking reaction at temperatures of 160° C., 130° C., and 100° C. for 4 hours, 8 hours, and 12 hours. Then, the product was washed with ethanol and dried at a temperature of 50° C. for three hours to manufacture a DPVDF-coated and crosslinked separator for lithium ion secondary batteries.

In addition, DPVDF-coated and crosslinked separators for lithium ion secondary batteries were separately manufactured using PVDF, PET, and PES materials by same method as the methods in 1 and 2 above.

### Example 3. Properties of DPVDF-Coated Separator for Lithium Ion Secondary Batteries

For reference, in the SEM photographs and graphs attached to the examples and drawings, ‘PP’ refers to a PP separator that was not coated with DPVDF, ‘DPS’ refers to a PP separator that was coated with DPVDF, and ‘DPSX’ refers to a PP separator coated with DPVDF and then crosslinked.

### Experimental Example 1. Analysis of Pore Structure Morphology

SEM imaging was performed with a PP separator that was not coated with DPVDF and PP separators that were coated by immersing the PP separator in a dipping solution formed by dissolving DPVDF in an acetone solvent each at 0.1%, 0.5%, 1%, 3%, 5%, 7%, and 9% by weight. As a result, as shown in FIG. 2, the surface pore structure morphology changed from 5% by weight.

For reference, FIG. 2 attached to the present specification shows SEM photographs of surface pore structure morphology of separators manufactured by dipping a separator in an acetone solvent in which DPVDF was dissolved at different concentrations and then drying it. The SEM photographs were taken at a magnification of ×50,000 up to 3% by weight and then at a magnification of ×7,500.

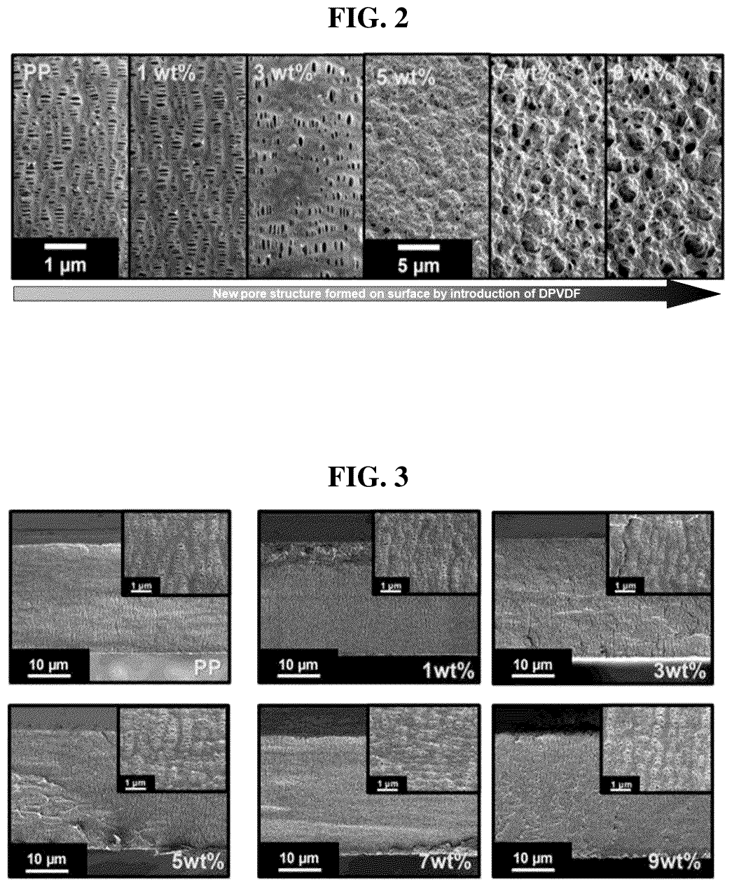

In addition, as shown in FIG. 3, it could be confirmed that the thickness did not increase when viewed at the cross-section, and it could be confirmed that the pore structure of the cross-section was also almost unchanged.

For reference, FIG. 3 attached to the present specification shows SEM photographs of cross-sectional pore structure morphology of separators manufactured by dipping a separator in an acetone solvent in which DPVDF was dissolved at different concentrations and then drying it. The SEM photographs of the whole cross-sections were taken at a magnification of ×5,000 and the magnified photographs were taken at a magnification of ×50,000.

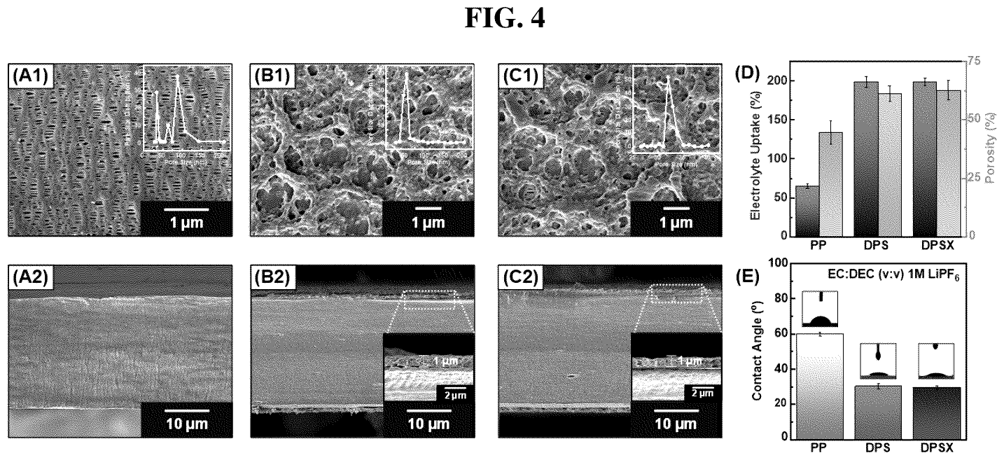

As a result of the DVPDF dip coating separator shape morphology, it could be confirmed from the results of measuring the pore size of PP, DPS, and DPSX, as shown in FIG. 4, A1, B1, and C1, due to the adaptation of the dip coating method, the micropores in the separator were coated and thus the mean pore size was decreased from 36.8 nm to 28.7 nm, and it could be confirmed that cohesion of the polymer matrix (DPSX) occurred during the heat treatment process after crosslinking and during crosslinking process, and as a result, the pore size was slightly increased.

As a result of a pore size analysis for PP, DPS, and DPSX, as shown in Table 4 below, the mean pore size was 25 μm, 27 μm, and 27 μm, indicating that the thickness of DPS and DPSX before and after crosslinking remained unchanged as 27 μm.

In addition, it can be confirmed that the porosity of the separator increased in FIG. 4, (D) because a new pore structure was formed on the surface, and it can be confirmed the electrolyte uptake and affinity to electrolyte were increased by the introduction of an excellent polymer and the increase of the porosity.

In addition, it can be confirmed that the coating thickness of DPS and DPSX increased by 1 μm each in the upper direction and lower direction, as can be seen in FIG. 4, B2 and C2.

In addition, as shown in FIG. 4, (E), measurement was conducted to show that the affinity to an electrolyte was increased, and it can be confirmed that the electrolyte contact angle decreased because a fluorine-based polymer with excellent electrolyte affinity was introduced to the surface.

For reference, FIG. 4 attached to the present specification shows surface and cross-sectional SEM images of (A1, A2) PP separator, (B1, B2) DPS, and (C1, C2) DPSX, (D) electrolyte uptake and porosity of PP, DPS, and DPSX, and (E) electrolyte contact angles of PP, DPS, and DPSX.

### Experimental Example 2. Conditions of DPVDF Dip-Coated Separator

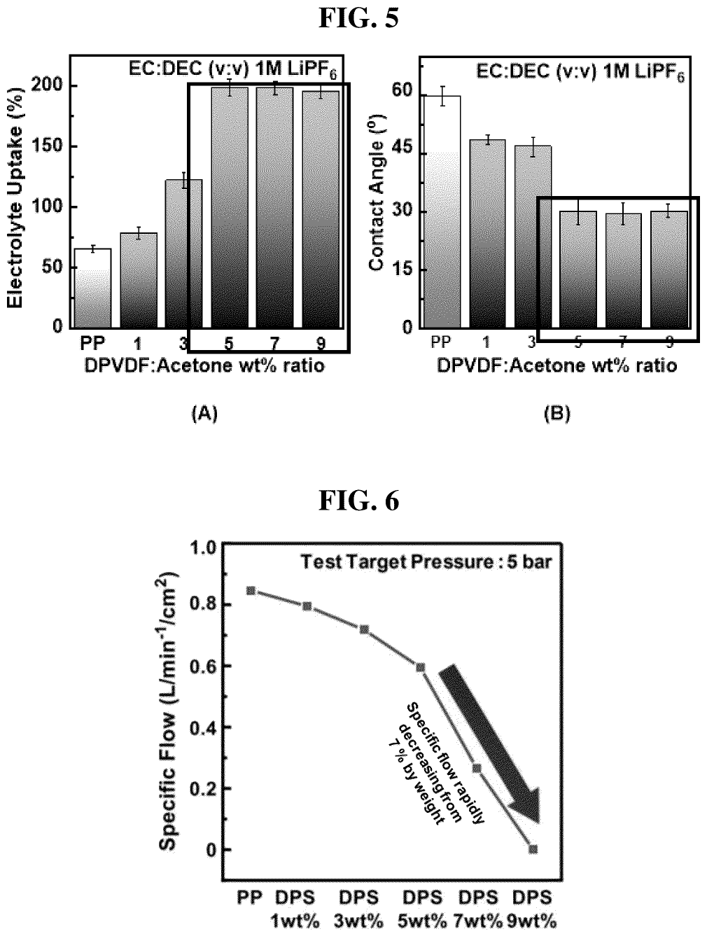

Electrolyte uptake, one of the indicators of performance evaluation of separators for secondary batteries, is a key factor in determining ionic conductivity of separators for lithium batteries. As a result of performing an electrolyte uptake test using an ultra-precision electronic scale, as shown in FIG. 5, A and Table 2, it could be confirmed that the electrolyte uptake was saturated above 5% by weight, and as a result of analyzing the electrolyte contact angle using SEO's Phoenix300, as shown in FIG. 5, B and Table 2, it could be confirmed that the contact angle was saturated starting from 5% by weight. Therefore, it can be confirmed that since morphology was formed on a new surface and the affinity to the electrolyte was excellent, the uptake of the electrolyte was relatively more.

TABLE 2

| | Coating | | | | | |
|---|---|---|---|---|---|---|
| | solution | | Electrolyte | Electrolyte | | Coating |
| Coating | concentration | | Uptake | Contact | Porosity | Thickness |
| material | (wt %) | Solvent | (%) | Angle (°) | (%) | (μm) |
| DPVDF | 0.1 | Acetone | 68.35 | 59.98 | 47.32 | 0.08 |
| | 0.5 | | 69.43 | 54.10 | 46.54 | 0.12 |
| | 1 | | 80.23 | 48.54 | 40.32 | 0.35 |
| | 3 | | 124.35 | 43.22 | 42.64 | 0.57 |
| | 5 | | 203.12 | 29.66 | 50.64 | 1.05 |
| | 7 | | 205.34 | 28.74 | 48.21 | 1.58 |
| | 9 | | 212.21 | 28.64 | 46.66 | 2.21 |

In addition, as shown in FIG. 6, as a result of analyzing gas permeability of the separators using Porometer's Porolux 1000, it could be confirmed that the gas permeability decreased rapidly starting from 7% by weight, so there is a risk of performance deterioration when coating more than 7% by weight of DPVDF.

For reference, FIG. 5, A attached to the present specification is a graph showing electrolyte uptake, FIG. 5, B is a graph showing the measurement results of contact angle, Table 2 shows the numerical values of the electrolyte uptake, contact angle, porosity, and thickness of the PP separators coated by immersing in a dipping solution formed by dissolving DPVDF in each at 0.1%, 0.5%, 1%, 3%, 5%, 7%, and 9% by weight, and FIG. 6 is a graph showing the results of a gas permeability analysis of the separators.

### Experimental Example 3. Electrical Conductivity Properties

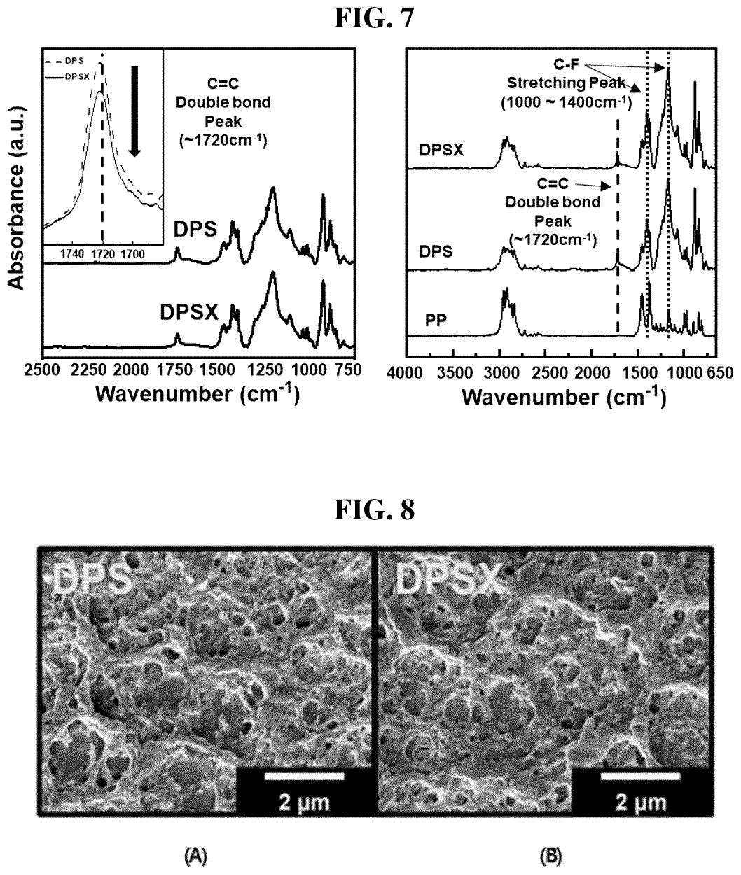

As a result of analyzing the electrical conductivity properties of PP, DPS, and DPSX using Biologic's SP-240 Potentiostat, it could be confirmed that actual swelling was suppressed and the mechanical properties were increased in DPSX since the crosslinking reaction increased thermal stability and affinity to an electrolyte. As a result of an FT-IR analysis, as illustrated in FIG. 7, the peak corresponding to a C═C double bond was lowered, and thus it could be confirmed that the separator was crosslinked, and as illustrated in FIG. 8, the morphology remained unchanged even after the crosslinking.

For reference, FIG. 7 attached to the present specification shows graphs showing a crosslinking effect of a DPS separator by an FT-IR analysis, and FIG. 8 shows an FE-SEM morphology analysis photograph (×7500).

### Experimental Example 4. Analysis of Physical Properties and Thermal Properties

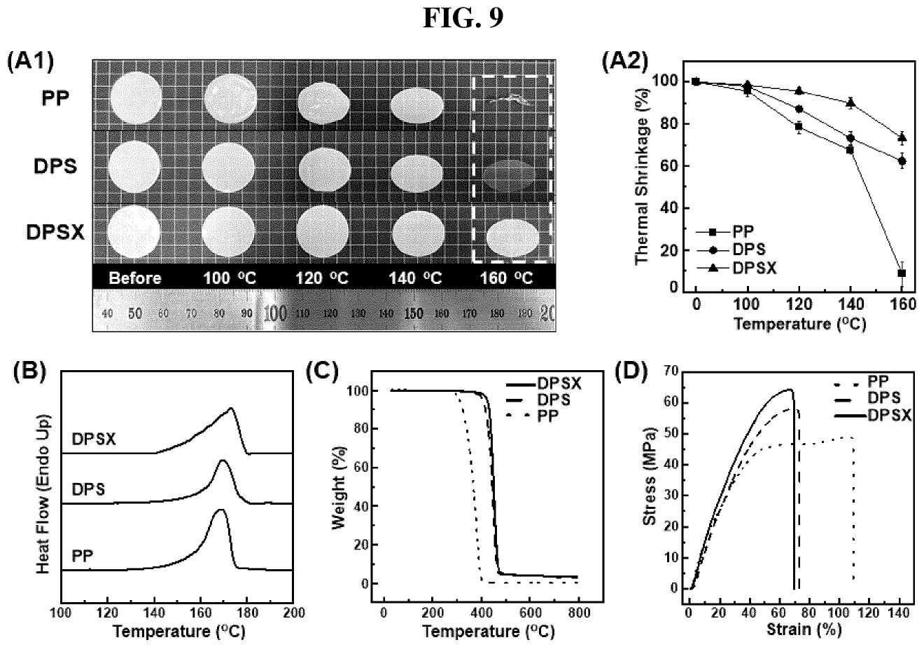

As a result of analyzing the physical properties and thermal properties of PP, DPS, and DPSX using an autoclave oven, as illustrated in FIG. 9, A, existing PP showed a tendency to completely shrink at 160° C., and DPS also showed a tendency to shrink at 160° C. with the pores closed and the separator turning to be transparent.

However, DPSX showed a tendency to maintain its shape even at 160° C. without being completely melted.

In addition, as a result of performing DSC and TGA analyses to analyze the thermal properties of DPSX, as illustrated in FIG. 9, A2 to D, it could be confirmed that in the DSC, the Tₘ (melting point of the polymer) was shifted to the right compared to the existing PP, and with regard to the thermal decomposition temperature also, compared to the existing PP of which decomposition started at about 300° C., the decomposition started at about 430° C., and the decomposition of DPSX started at 470° C., which is about 40° C. higher compared to DPS. Table 3 also shows that the temperature of Tₘ tended to gradually increase compared to PP, and so it could be confirmed that the separator was stable at high temperatures as crosslinking progressed.

TABLE 3

| Sample | Tg (° C.) | Tm (° C.) |
|---|---|---|
| PP | Absent | 168.94 |
| DPS | −36 | 174.04 |
| DPSX | Absent | 178.21 |

In other words, as a result of this analysis, it could be confirmed that a fluorine-based separator with excellent physical properties was coated, so the tensile elongation decreased in the tensile strength test, but the breakage point tended to increase. In the case of DPSX, movement between polymer chains was suppressed through the crosslinking reaction between polymers and the properties were increased through bonding, and it could be confirmed that the breakage point also tended to increase as the tensile elongation slightly decreased.

For reference, FIG. 9 attached to the present specification shows a photograph showing the results of a thermal property analysis of the separators and a graph showing the results of the thermal property analysis, and Table 3 numerically shows the graph of the results of the thermal property analysis of the separators according to FIG. 9, B.

### Experimental Example 5. Stability and Ionic Conductivity Analyses

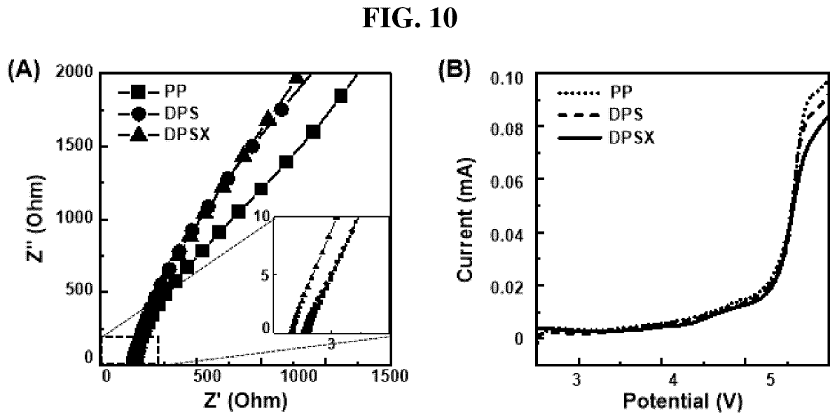

The stability and ionic conductivity of PP, DPS, and DPSX were analyzed using Biologic's SP-240 Potentiostat. FIG. 10, A shows the results of an analysis to confirm the stability of the separators and the ionic conductivity of the separators themselves. The X-intercept value of Rs (R_{bulk}) in FIG. 10, A represents the resistance of the separators themselves, and the ionic conductivity of the separators calculated based on this is as shown in Table 4 below.

In addition, FIG. 10, B shows the results of confirming whether the separator is electrochemically stable or not using an analytical method of linear sweep voltammetry (LSV), and it could be confirmed that that the separator behaves in an electrochemically stable manner at a cut-off voltage value of 2.5 V to 4.2 V, and as the current value increases, the separator is stable up to 4.2 V and participates in an electrochemical reaction from about 4.5 V, and as the current value greatly increases above 5.5 V, the separator is stable in the charge-discharge region of 2.5 V to 4.2 V.

For reference, FIG. 10 attached to the present specification shows graphs showing the results of an analysis on ionic conductivity and electrochemical stability of the separators.

### Experimental Example 6. Electrochemical Analysis

Electrochemical analysis of PP, DPS, and DPSX was performed using WonATech's WBCS3000 charger-discharger to confirm the behavior of the separator according to the charge-discharge rates.

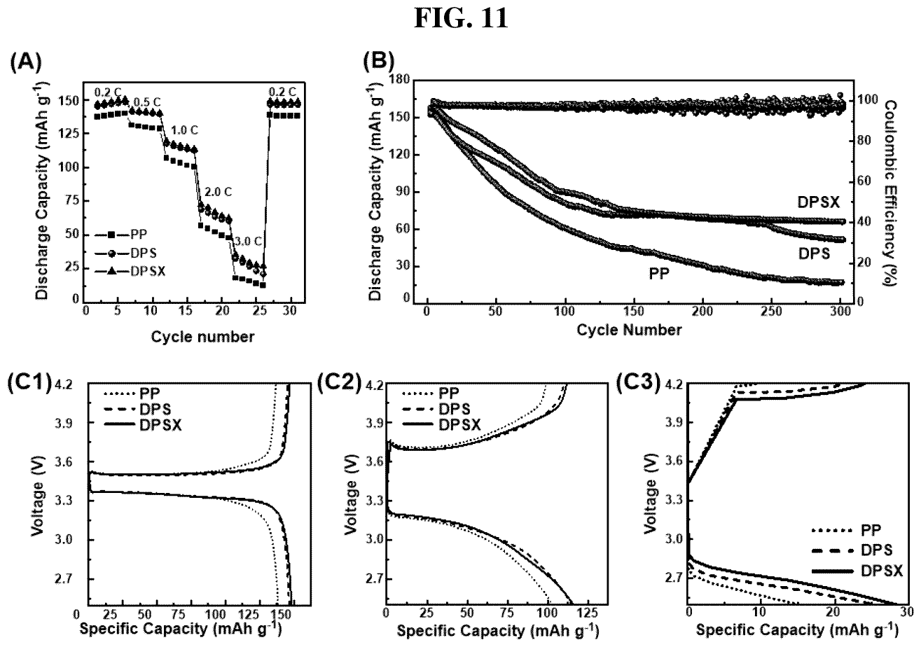

As illustrated in FIG. 11, A, as a result of analyzing the characteristics for 0.2 C, 0.5 C, 1.0 C, 0.2 C, and 3 C, the initial charge-discharge results showed superior initial capacity and charge-discharge performance compared to PP.

In addition, as illustrated in FIG. 11, B, as a result of analyzing the performance for long-term cycling, it could be confirmed that the discharge capacity of the PP separator, which was initially 156 mAh/g, decreased to about 15 mAh/g after charging and discharging at a rate of 1 C for 300 cycles, whereas the crosslinked separator exhibited a discharge capacity of about 40 mAh/g, indicating superior charge-discharge performance compared to the existing PP separator.

In addition, FIG. 10, C1, C2, and C3 show voltage profiles for charge-discharge for 0.2 C, 1.0 C, and 3.0 C (according to the charge-discharge speed rates), and the charge-discharge capacity could be confirmed based on the end point on the X-axis at the cut-off voltage (2.5 V and 4.2 V) through interpretation of the graphs, indicating that discharge capacity retention of DPSX according to voltage changes is superior to PP.

When the test was conducted while changing the charge-discharge rate, the higher the C rate, the more the change in charge-discharge capacity between the separators. As a result of conducting a long-term charge-discharge test at 1.0 C-rate for 300 cycles, it could be confirmed that the charge-discharge capacity retention of the separator was higher in DPSX than in PP.

For reference, FIG. 11 attached to the present specification shows graphs showing the results of an electrochemical analysis of the separators.

### Experimental Example 7. Charge-Discharge Analysis

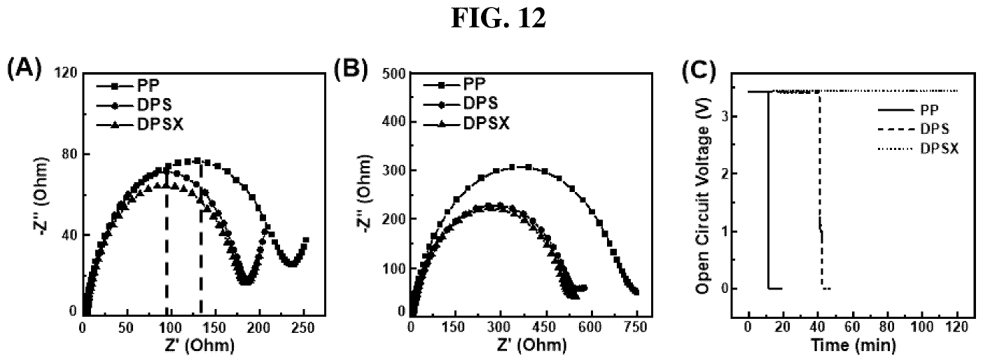

As a result of performing a charge-discharge analysis on PP, DPS, and DPSX using Biologic's SP-240 Potentiostat, as shown in FIG. 12, A, Rct, indicated by a dotted line, is a value representing the degree of dispersion (resistance) of lithium ions within an electrode, and it can be confirmed that the Rct value decreases as the ionic conductivity of the separator increases.

The reason why the Rct value of DPSX decreased was because the pore structure was improved during the crosslinking and heat treatment process, and the path through which lithium ions are transported was improved accordingly, and as shown in the data in FIG. 11, B, it can be confirmed that the charge-discharge capacity of DPSX is superior to PP.

FIG. 12, B shows the result of measuring the resistance value after the charge-discharge test of the data in FIG. 11, B, and it could be confirmed that the ionic conductivity value increased compared to the value before the charge-discharge test. However, it could be confirmed that the separator resistance was lower in DPS and DPSX than in PP.

FIG. 12, C shows the results to confirm that the separators applied to actual secondary cells are stable at a high temperature. The results were obtained by measuring an open circuit voltage (OCV, voltage measured without applying a current) at 140° C., and it could be confirmed that the voltage was dropped to 0 after about 10 minutes at 140° C.

A voltage dropped to 0 means that the separator shrank and the cathode and the anode came into contact and that an internal short circuit (commonly referred to as “short”) occurred, causing the voltage to drop to 0.

On the other hand, it can be confirmed that DPS stably lasted for up to 40 minutes, whereas DPSX stably behaved for two hours even in an oven at 140° C.

For reference, FIG. 12 shows graphs showing the results of measuring electrical conductivity and open circuit voltage of the separators.

For reference, the exact numerical data of the mean pore size formed in the DPVDF dip-coated separator is as shown in Table 4 below.

TABLE 4

| | | | | | Electrolyte | | | | |
|---|---|---|---|---|---|---|---|---|---|
| | | | | Electrolyte | Contact- | Ionic | | Young's | Elongation |
| | Mean Pore | Porosity | Thickness | Uptake | Angle | Conductivity | Specific Gas Flow | Modulus | Brake |
| | Size (nm) | (%) | (μm) | (%) | (°) | (10⁻²Scm⁻¹) | (L min⁻¹ cm⁻²) | (MPa) | (%) |
| PP | 36.8 | 43.07 | 25 | 65.25 | 59.78 | 1.24 | 0.846 | 49.06 | 107.83 |
| DPS | 28.7 | 58.94 | 27 | 196.63 | 30.20 | 1.29 | 0.637 | 57.97 | 71.71 |
| DPSX | 32.87 | 60.12 | 27 | 198.46 | 30.55 | 1.41 | 0.718 | 64.29 | 67.42 |

As confirmed in the above examples above, a separator for lithium ion secondary batteries according to the present invention is surface-modified using PVDF-CTFE which is a polymer compound synthesized by dehydrochlorination of PVDF, an existing fluorine-based polymer material, and thus has excellent effects of exhibiting excellent thermal stability, as surface morphology before dip coating is maintained even after dip coating and exhibiting improved solubility of an electrolyte, and excellent electrochemical performance in charge-discharge performance compared to existing PP separators, as a path through lithium ions are transported is improved due to the improvement of pore structure and thus the ion conductivity of the separator is increased.

### Experimental Example 8. Test of Flame Resistance of Separators

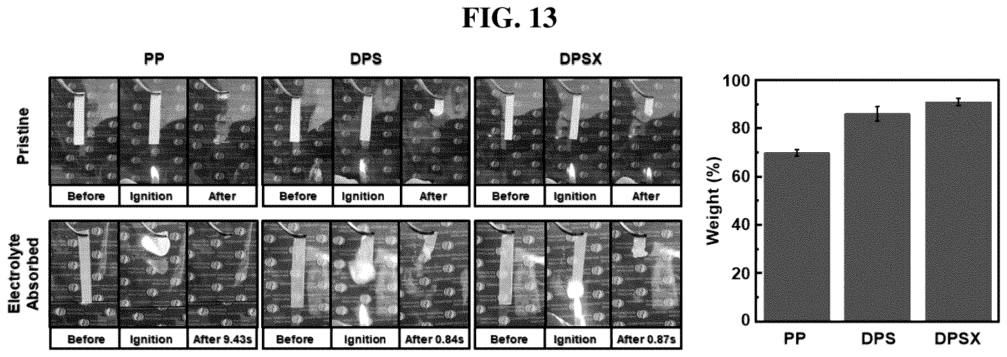

As a result of testing the flame resistance of the separators using a portable small igniter, as shown in FIG. 13, it could be confirmed that the PP separator in a dry state shrank immediately after contacting with a flame, but the DPS and DPSX, to which the thermally stable fluorine-based polymer (DPVDF) had been introduced, maintained their shape to some extent thereafter, and the weight of the PP separator after combustion was 69.70%, but the weight of the separators to which the fluorine-based polymer had been introduced was 85.93% and 90.78%, indicating the weight loss was less after combustion.

Even when electrolyte was taken up, the PP separator was combusted after blazing for about 9.43 seconds, but the separators to which the fluorine-based polymer had been introduced were combusted after blazing for 0.84 seconds and 0.87 seconds, indicating that the separators have excellent flame resistance.

For reference, FIG. 13 shows photographs showing the results of a flame resistance test of separators and the results of a weight analysis after combustion.

Meanwhile, in the case of the separators made of PVDF, PET, and PES materials, the pore structure formed after coating was slightly different for each material, but it could be confirmed that a porous pore structure was formed after the dip coating method even through the structures and materials were different.

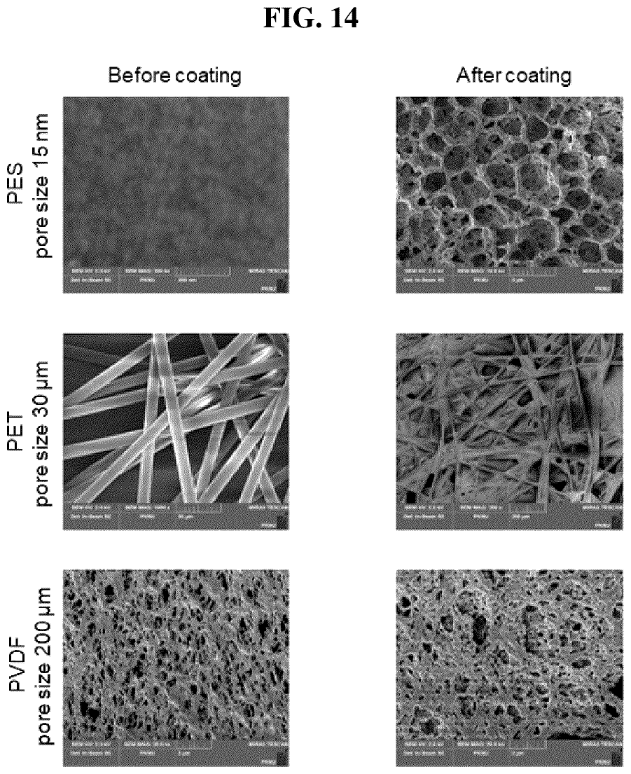

For reference, FIG. 14 attached to the present specification shows SEM photographs (×20,000, ×200, ×10,000) of pore structures formed in each separator made of PVDF, PET, and PES materials.

As described above, a separator for lithium-ion secondary batteries with improved charge-discharge performance and thermal stability and a method for manufacturing the same according to a preferred embodiment of the present invention have been described, but this is only an example, and those skilled in the art will be able to well understand that various changes and modifications are possible within the scope of the technical ideas of the present invention.

What is claimed is:

1. A separator for lithium-ion secondary batteries with improved charge-discharge performance and thermal stability, characterized in that DPVDF is dip-coated on the separator and crosslinked.

2. The separator for lithium-ion secondary batteries with improved charge-discharge performance and thermal stability according to claim 1, characterized in that a material of the separator is selected from polyethylene (PE), polypropylene (PP), cellulose acetate (CA), polyvinylidene fluoride (PVDF), polyethersulfone (PES), or polyethylene terephthalate (PET).

3. The separator for lithium-ion secondary batteries with improved charge-discharge performance and thermal stability according to claim 1, characterized in that the separator is coated with 0.05% to 10% by weight of DPVDF.

4. The separator for lithium-ion secondary batteries with improved charge-discharge performance and thermal stability according to claim 1, characterized in that pore are formed in the separator, and the size of the pores is 10 nm to 35 μm in diameter.

5. The separator for lithium-ion secondary batteries with improved charge-discharge performance and thermal stability according to claim 1, characterized in that a coating thickness of DPVDF in the separator is 0.05 to 3 μm.

6. A method for manufacturing a separator for lithium-ion secondary batteries with improved charge-discharge performance and thermal stability, comprising:
a step (S100) of synthesizing polyvinylidene fluoride (DPVDF) including a double bond by dehydrochlorinating poly(vinylidene fluoride-co-chlorotrifluoroethylene [P(VDF-CTFE)];
a step (S200) of coating a separator by dipping in a dipping solution formed by dissolving the DPVDF in an organic solvent; and
a step (S300) of crosslinking the DPVDF coated on the separator by performing a radical reaction by heat treatment.

7. The method for manufacturing a separator for lithium-ion secondary batteries with improved charge-discharge performance and thermal stability according to claim 6, characterized in that in the step S100, synthesis is performed by adding P(VDF-CTFE) into an organic solvent and dissolving therein and then adding an amine-based organic catalyst.

8. The method for manufacturing a separator for lithium-ion secondary batteries with improved charge-discharge performance and thermal stability according to claim 6, characterized in that in the step S300, a radical initiator is selected from 2,2′-azobisisobutyronitrile (AIBN), benzoyl peroxide (BPO), lauryl peroxide, azobisisocapronitrile, azobisisovaleronitrile, methyl ethyl ketone peroxide (MEKP), potassium persulfate, di-tert-butyl peroxide, or 1,1′-dihydroxydicyclohexyl peroxide.

9. The method for manufacturing a separator for lithium-ion secondary batteries with improved charge-discharge performance and thermal stability according to claim 6, characterized in that in the step S300, a crosslinking reaction is performed for 4 to 12 hours at a temperature of 70 to 150° C.
